(19) United States
(12) Patent Application Publication
(10) Pub. No.: US 2022/0343031 A1
(43) Pub. Date: Oct. 27, 2022

(54) APPARATUS AND METHOD OF DETECTING CACHE SIDE-CHANNEL ATTACK

(71) Applicant: Korea University Research and Business Foundation, Seoul (KR)

(72) Inventors: Hodong KIM, Seoul (KR); Junbeom HUR, Yongin-si (KR)

(73) Assignee: Korea University Research and Business Foundation, Seoul (KR)

(21) Appl. No.: 17/333,198

(22) Filed: May 28, 2021

(30) Foreign Application Priority Data
Apr. 23, 2021 (KR) 10-2021-0052916

(51) Int. Cl. G06F 21/75; G06N 20/00; G06N 5/04

(52) U.S. Cl. CPC G06F 21/755; G06N 20/00; G06N 5/04

(57) ABSTRACT

Disclosed are an apparatus for detecting a cache side-channel attack which is capable of quickly detecting the cache side-channel attack in real time with high accuracy and a method thereof. The apparatus for detecting the cache side-channel attack may include a data collection unit that collects data from at least one of a core, an L1 cache, an L2 cache, and an L3 cache, respectively, and a data collection unit that collects data from at least one of a core, an L1 cache, an L2 cache, and an L3 cache, respectively.

### CROSS-REFERENCE TO RELATED APPLICATIONS

This application claims priority under 35 U.S.C. § 119 to Korean Patent Application No. 10-2021-0052916 filed on Apr. 23, 2021, in the Korean Intellectual Property Office, the disclosures of which are incorporated by reference herein in their entireties.

### BACKGROUND

Embodiments of the present disclosure described herein relate to an apparatus for detecting cache side-channel attack and a method thereof.

A central processing unit (CPU) uses a cache memory, which is a temporary storage medium, for high-speed processing of operations. The cache memory may store various types of data that are frequently used, are determined to be used, or will be used soon in a process for running a program, and may provide the stored data to the central processing unit in request. Therefore, the cache memory shortens data access time and operation time, thereby enabling the central processing unit to quickly perform an operation processing.

A cache side-channel attack refers to unauthorized acquisition of information from an attack target device by extracting and analyzing various traces (records, deletions, or the like) which occur in the cache memory according to an operation of the central processing unit. Various electronic devices, such as a desktop computer, a laptop computer, a server computer, a smartphone, or the like may be targeted for the cache side-channel attack, and various information such as an encryption secret key, internet browser history, a firewall rule, a password, or a mobile phone lock pattern may be targeted. The cache side-channel attack includes Flush+Reload Attack and Prime+Abort Attack. The Flush+Reload Attack is a method in which an attacker deletes data in the cache memory (a flush process) and then measures a time required for accessing the deleted data (reload process) to obtain data on an execution flow of an attack target device. The Prime+Abort Attack is a method to allow an attacker to determine an execution flow of a target using a transaction abort hardware callback that occurs when an attacker writes data to a cache group that an attacker wants to monitor (a prime process), and a victim removes data recorded by the attacker to load the data into the cache (an abort process).

As described above, according to the cache side-channel attack, important secret data of the attack target device may be unauthorized, and thus detecting and blocking the cache side-channel attack is important in security of a hardware device. However, because a detailed setting of the cache side-channel attack method is different depending on the hardware or software to be attacked, even when the attack is of the same technique, phenomenon observed from the outside may be different depending on the attack target. This not only means that a high degree of expertise is required for detection and determination of whether the cache side-channel attack exists, but it also means that it is difficult to expect highly accurate attack detection using only a conventional standardized method. In addition, depending on technique, the cache side-channel attack has little or no effect on the target device, and the victim may not be able to perceive the attack. Further, even when the victim is able to perceive the attack, the attack is performed for a very short time of several seconds or less, and thus it is very difficult to sense, detect, and respond to the attack.

### SUMMARY

Embodiments of the present disclosure provide an apparatus for detecting a cache side-channel attack which enables rapid detection of a cache side-channel attack in real time with high accuracy, and a method of detecting a cache side-channel attack.

To solve the above problems, an apparatus for detecting a cache side-channel attack and a method of detecting a cache side-channel attack are provided.

According to an embodiment, an apparatus for detecting a cache side-channel attack may include a data collection unit that collects data from at least one of a core, an L1 cache, an L2 cache, and an L3 cache, respectively, and a data collection unit that collects data from at least one of a core, an L1 cache, an L2 cache, and an L3 cache, respectively.

According to an embodiment, a method of detecting a cache side-channel attack may include collecting data from at least one of a core, an L1 cache, an L2 cache, and an L3 cache, respectively, and obtaining a detection result corresponding to the data using at least one trained learning model.

### BRIEF DESCRIPTION OF THE FIGURES

The above and other objects and features of the present disclosure will become apparent by describing in detail embodiments thereof with reference to the accompanying drawings.

FIG. 1 is a block diagram of an apparatus of detecting a cache side-channel attack according to an embodiment;

FIG. 2 is a diagram illustrating an example of a process of collecting data from a processor;

FIG. 3 is a diagram illustrating an example of a training process of a learning model;

FIG. 4 is a diagram illustrating an example of a detection process based on a learning model; and

FIG. 5 is a flowchart illustrating an embodiment of a method of detecting a cache side-channel attack.

### DETAILED DESCRIPTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, exemplary embodiments of the present disclosure will be described in detail with reference to the accompanying drawings. However, the scope of the patent application is not confined or limited by these embodiments. The same reference numerals in each drawing indicate the same members.

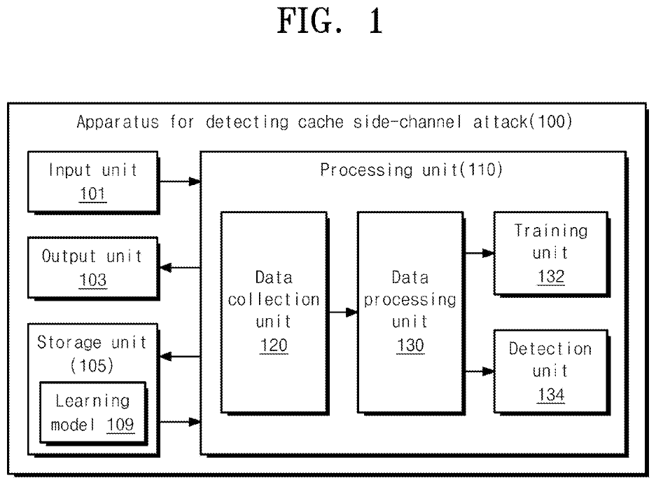

Hereinafter, an embodiment of an apparatus for detecting a cache side-channel attack will be described with reference to FIGS. 1 to 4.

FIG. 1 is a block diagram of an apparatus of detecting a cache side-channel attack according to an embodiment.

Referring to FIG. 1, an apparatus 100 for detecting a cache side-channel attack may include an input unit 101, an output unit 103, a storage unit 105, and a processing unit 110. Here, at least two of the input unit 101, the output unit 103, the storage unit 105, and the processing unit 110 are provided to transmit data or instructions/commands to one side or to each other through a cable or circuit line.

When necessary, at least one of the input unit 101, the output unit 103, and the storage unit 105 may be omitted.

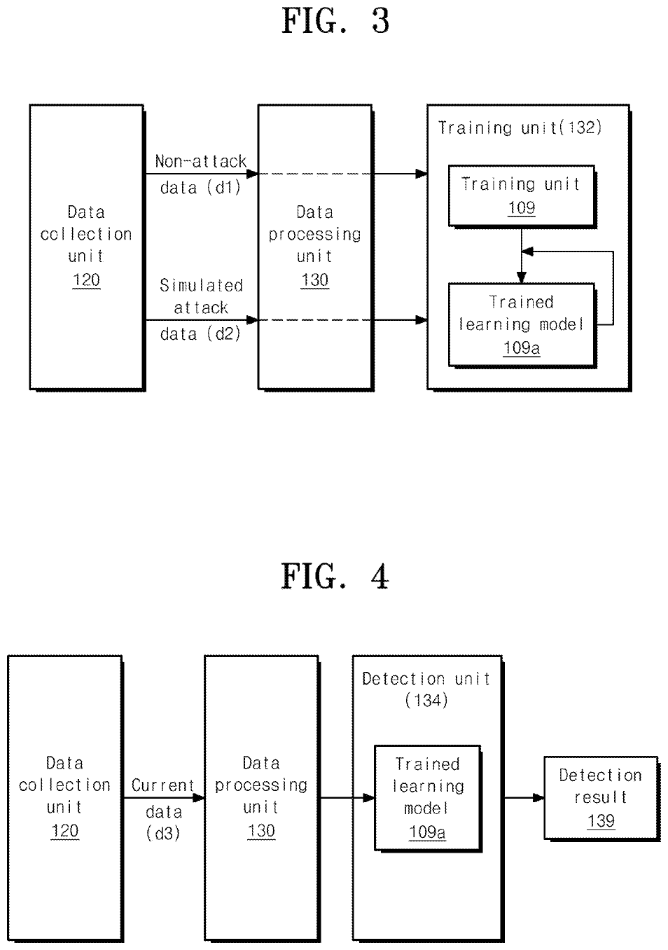

The input unit 101 may receive data, instructions/commands, or programs (which are referred to as apps, applications, or software) from a designer, user, or other external device (not shown), and may transmit the received data, instructions/commands or programs to at least one of the storage unit 105 and the processing unit 110. For example, the input unit 101 may receive an algorithm for a cache side-channel attack (hereinafter, referred to as a simulated attack) performed for training a learning model 109, data thereof, and/or an instruction thereof. Also, the input unit 101 may receive at least one learning model (109a of FIG. 3 or 4) trained by another data processing unit (not shown). The input unit 101 may be provided integrally with the apparatus 100 for detecting the cache side-channel attack or may be provided to be physically separated. The input unit 101 may include a keyboard, a mouse, a tablet, a pressure sensor, a motion sensor, a light sensor, a touch screen, a touch pad, a scanner, an image capturing module, a microphone, a trackball and/or a trackpad, and the like, and may include a data input/output terminal capable of receiving data from a device (a memory device or the like), or a wired or wireless communication module (e.g., a LAN card, a short-range communication module, a mobile communication module, or the like) that is connected to other external devices through a wired or wireless communication network.

The output unit 103 is provided to output a processing result of the processing unit 110 to the outside. For example, the output unit 103 visually or audibly outputs data on a detection process of the cache side-channel attack by the processing unit 110, a detection result, or a warning message corresponding thereto, thereby being notified to an administrator or user of the apparatus 100 for detecting the cache side-channel attack, and/or transmitting the detection result or the warning message to an external electronic device (e.g., a smart phone or a desktop computer). When necessary, the output unit 103 is capable of transmitting the learning model 109a trained by the processing unit 110 to another external data processing unit (not shown, for example, another cache side-channel attack detection device). In this case, the another external data processing unit may perform detection on the cache side-channel attack through the same or some different method as described later using the trained learning model 109a received from the apparatus 100 for detecting the cache side-channel attack. The output unit 103 may include a display device (a monitor device), a printer device, a speaker device, an image output terminal, a data input/output terminal, a wired communication module, and/or a wireless communication module, but is not limited thereto.

The storage unit 105 may temporarily or non-temporarily store at least one data or program related to the apparatus 100 for detecting cache side-channel attack. For example, the storage unit 105 may store the detection result of the cache side-channel attack, the warning message corresponding to the detection result, a history of the detection process, a pre-trained learning model 109, and/or the trained learning model 109a. Here, the pre-trained learning model 109 and/or the trained learning model 109a may be implemented based on at least one machine learning model that a designer is capable of considering, such as a multi-layer perceptron, a support vector machine (SVM), and a deep neural network (DNN), a convolutional neural network (CNN), a recurrent neural network (RNN), a deep belief network (DBN), a deep Q-network, a long and short term memory (LSTM), a generative adversarial network (GAN), and/or conditional GAN (cGAN). In addition, the storage unit 105 may store at least one program to be driven by the processing unit 110 to detect the cache side-channel attack. Here, the at least one program may be implemented by singly or in combination with a performance counter monitor (PCM) program and/or the pre-trained learning model 109 or the trained learning model 109a. The at least one program may be a separate program specially designed to detect the cache side-channel attack, or may be a real-time attack detection program or a vaccine program designed and manufactured including a cache side-channel attack detection operation. The at least one program may be directly written by a designer, and may be input, stored, or modified in the storage unit 105, or may be obtained or updated through an electronic software distribution network accessible through a wired or wireless communication network.

The storage unit 105 may be implemented using at least one of a main memory device and an auxiliary memory device. Here, the main memory device may include a semiconductor storage medium such as ROM or RAM, and the auxiliary memory device may include at least one storage medium capable of permanently or semi-permanently storing data, such as a flash memory device, a secure digital (SD) card, and a solid state drive (SSD), a hard disk drive (HDD), a compact disk (CD), a DVD, a magneto-optical disk, and/or a floppy disk.

The processing unit 110 is provided to detect the cache side-channel attack, and to obtain and output the detection result. In addition, the processing unit 110 may further perform training processing of the learning model 109 to be used for detecting the channel side-channel attack. When necessary, the processing unit 110 may perform an operation, determination, or control processing related to the overall or partial operation of the apparatus 100 for detecting cache side-channel attack. In this case, the processing unit 110 may perform the above-described operation by simultaneously or sequentially driving the at least one program stored in the storage unit 105.

The processing unit 110 may include a central processing unit (CPU), a microcontroller unit (MCU), a microprocessor (Micom), an application processor (AP), and an electronic control unit (ECU), and/or other electronic devices capable of processing various operations and generating control signals. These devices may be implemented using one or more semiconductor chips.

According to an embodiment, the processing unit 110 may include a data collection unit 120, a data processing unit 130, a training unit 132, and a detection unit 134, as shown in FIG. 1.

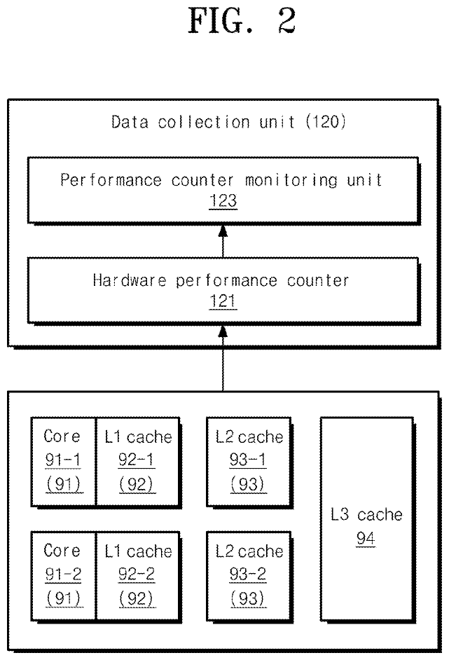

FIG. 2 is a diagram illustrating an example of a process of collecting data from a processor.

The data collection unit 120 may collect and obtain at least one data necessary for detection and determination of the cache side-channel attack, and may transmit the collected and obtained the at least one data to at least one of the data processing unit 130, the training unit 132, and the detection unit 134 directly or via another device. According to an embodiment, the data collection unit 120 may collect data related to an operation of hardware such as a processor (e.g., a central processing unit). Here, the processor may be provided to perform operations and functions of the data collection unit 120, the data processing unit 130, the training unit 132, and/or the detection unit 134. That is, the processor that is a data collection target of the data collection unit 120 may be the processing unit 110, and in this case, the processing unit 110 (i.e., the data collection unit 120) collects data on its own activities. In addition, according to an embodiment, the processor that is the data collection target of the data collection unit 120 may be one or more other processors (not shown) provided separately from the processing unit 110, and the processing unit 110 may collect data on an operation of another processor from another processor.

As shown in FIG. 2, the processor which is the data collection target may include at least one core 91: 91-1, 91-2 for performing calculation/processing, and at least one L1 cache 92: 92-1, 92-2 corresponding to the at least one core 91: 91-1, 91-2, respectively. In addition, the processor which is the data collection target may further include at least one L2 cache 93: 93-1, 93-2 corresponding to the at least one core 91: 91-1, 91-2, respectively. And the processor may further include at least one L3 cache 94 corresponding to the plurality of cores 91. The at least one L2 cache 93: 93-1, 93-2 or the at least one L3 cache 94 may be provided integrally with a central processing unit, or may be provided physically separate. As described above, the data collection unit 120 may obtain the data corresponding to the activities from the at least one core 91: 91-1, 91-2, the at least one L1 cache 92: 92-1, 92-2, the at least one L2 cache 93: 93-1, 93-2, and the at least one L3 cache 94, and thus may collect data necessary for detection and determination of the cache side-channel attack. When the plurality of cores 91: 91-1, 91-2 are provided, the data collection unit 120 may obtain data corresponding to the activity of the hardware from all of the plurality of cores 91: 91-1, 91-2 depending on a user's selection or preset, or may obtain data corresponding to the activity of the hardware from some of the plurality of cores 91: 91-1, 91-2. In the same way, when there are the plurality of L1 caches 92: 92-1, 92-2, the plurality of L2 caches 93: 93-1, 93-2, and/or the plurality of L3 caches 94, the data collection unit 120 may obtain data from all L1 caches 92: 92-1, 92-2, all L2 caches 93: 93-1, 93-2, and/or all L3 caches 94, or may obtain data from some of the L1 caches 92: 92-1, 92-2, some of the L2 caches 93: 93-1, 93-2, and/or some of the L3 caches 94.

According to an embodiment, to collect data on the attack detection from at least one of the cores 91: 91-1, 91-2, the L1 caches 92: 92-1, 92-2, the L2 cache 93: 93-1, 93-2, and the L3 cache 94, the data collection unit 120 may include at least one of a hardware performance counter 121 (HPC, referred to as a hardware counter) and a performance counter monitoring unit (PCM) 123. The hardware performance counter 121 may be provided to record a value (e.g., a count result of the activity of the hardware) related to the activity of hardware such as a processor. The hardware performance counter 121 may be implemented using a group of registers. Here, the group of registers may be specially prepared to store a count result according to the operation, or may be embedded into a processor such as a central processing unit. The number of registers in the group may vary depending on a type of processor or manufacturer. In addition, hardware-related activities include, for example, various events such as L1 cache miss, L2 cache miss, L3 cache miss, CPU cycle rate due to the L2 cache miss or L3 cache miss, L2 hit, L3 hit, data size and/or branch prediction error read from or written to a memory controller. The performance counter monitoring unit 123 may analyze an activity of a processor or the like. Specifically, for example, the performance counter monitoring unit 123 may obtain values related to the activity of the hardware for each core 91: 91-1, 91-2 using the value stored in the hardware performance counter 121, may be converted into a number that is capable of being checked by a user, or may form a graph based on the obtained number. In addition, the performance counter monitoring unit 123 may generate and output the obtained values as data in a given format (e.g., a CSV format). The performance counter monitoring unit 123 may be implemented in hardware or software according to an embodiment, and may be omitted when necessary. The data obtained by the hardware performance counter 121 or the performance counter monitoring unit 123 may be transmitted to the data processing unit 130.

Referring to FIG. 1, the data processing unit 130 may receive the data collected by the data collection unit 120, and may process the received data depending on a predefined or arbitrary setting by a user or a designer, thereby obtaining the processed data. As an example, the data processing unit 130 may analyze the data collected by the data collection unit 120, and data collection unit 120 may select data of high need or importance among the collected data, thereby enabling the data collection unit 120 to process the collected data. In this case, unselected data may be removed as needed. According to an embodiment, the data processing unit 130 may obtain each field of data collected by the data collection unit 120, and may perform a correlation analysis between each field and whether the attack is performed, thereby enabling data to be selected in a field of high need or importance. For example, when a calculation result for the correlation between the data field and the attack status exceeds a predefined threshold (e.g. 0.3), the data(s) of the data field may be selected, and data in other data fields may be deleted, thereby obtaining the processed data. According to an embodiment, the data processing unit 130 may be omitted. The data collected by the data collection unit 120 or the processed data obtained by the data processing unit 130 may be transmitted to at least one of the training unit 132 and the detection unit 134.

FIG. 3 is a diagram illustrating an example of a training process of a learning model.

The training unit 132 may receive data from the data collection unit 120 or the data processing unit 130, as shown in FIG. 3, and may perform training on the learning model 109 based on the received data, thereby obtaining the trained learning model 109a.

In more detail, for example, first, the data collection unit 120 may collect data related to the activity of the hardware (hereinafter, referred to as a non-attack data d1) in absence of the attack, and may transmit the non-attack data d1 to the data processing unit 130 or the training unit 132. The data processing unit 130 may select specific data (e.g., data of an important field) from the non-attack data d1 and may transmit the selected data to the training unit 132. The training unit 132 may input the non-attack data d1 or data selected from the non-attack data d1 into the learning model 109, thereby training the leaning model 109 for the absence of the attack. In addition, preceding, following and/or simultaneously, the data collection unit 120 may further collect data on the activity of the hardware under a simulated attack (hereinafter, a simulated attack data, d2), and may transmit the collected simulated attack data d2 to the data processing unit 130 or the training unit 132. The data processing unit 130 may select data of a specific field from the simulated attack data d2 in the same or partially modified form as described above, and may transmit the selected data to the training unit 132. The data selected from the simulated attack data d2 and the data selected from the non-attack data d1 may correspond to each other, and may be, for example, the same kind of data. The training unit 132 performs training on the learning model 109 in a simulated attack situation based on the simulated attack data d2 or data selected from the simulated attack data d2. Through this process, it is possible to obtain the trained learning model 109a to detect the presence of the attack by grasping operation of the hardware in the presence or absence of the attack. The trained learning model 109a may continuously be trained by repetitive input of the non-attack data d1 (or the data selected from the non-attack data d1) and/or the simulated attack data d2 (or the data selected from the simulated attack data d2). In addition, the trained learning model 109a may be further trained in a process of detecting the cache side-channel attack, which will be described later.

According to an embodiment, the training unit 132 may train a plurality of different learning models 109 from one another. Here, the plurality of different learning models 109 may be implemented based on heterogeneous learning model(s), or may be implemented based on a homogeneous learning model. For example, the training unit 132 may train each of the plurality of learning models 109 using the non-attack data d1 (or the data selected from the non-attack data d1) and the simulated attack data d2 (or the data selected from the simulated attack data d2). According to an embodiment, the training unit 132 may compare and evaluate each learning model 109 to select one or more learning models 109 with excellent accuracy, and/or may sequentially determine and add a ranking for each learning model 109 based on the accuracy (i.e., correct answer rate for the non-attack or simulated attack) of each learning model 109 determined in the training process of each learning model 109.

FIG. 4 is a diagram illustrating an example of a detection process based on a learning model.

Referring to FIG. 4, the detection unit 134 may receive data (hereinafter, referred to as a current data d3) for detecting whether the attack occurs from the data collection unit 120 or the data processing unit 130, may detect whether the cache side-channel attack occurs using the trained model 109a, and may obtain the detection result 139.

Specifically, the data collection unit 120 may collect the current data d3 for the attack detection from at least one of the cores 91: 91-1, 91-2, the L1 caches 92: 92-1, 92-2, the L2 cache 93, and the L3 cache 94 and may transmit the current data d3 to the data processing unit 130 or to the training unit 132. The data processing unit 130 may process the current data d3 and transmit it to the detection unit 134, and for example, may select predetermined data, such as data of a field of high need or importance, among the current data d3, and may transmit the selected data to the detection unit 134. According to an embodiment, the data obtained by the data collection unit 120 or the data processing unit 130 may also be transmitted to the training unit 132. The detection unit 134 may input the current data d3 obtained by the data collection unit 120 or data selected by the data processing unit 130 among the current data d3 into the trained learning model 109a. The trained learning model 109 may obtain the detection result 139 corresponding to the input data d3 based on the input data d3. Here, when the cache side-channel attack exists in hardware such as a processor, the trained learning model 109a outputs the detection result 139 indicating that the attack occurs in response to the input data d3. Conversely, when there is no cache side-channel attack in the hardware, different data d3 from the case where the cache side-channel attack exists is input to the trained learning model 109a, and the learning model 109a trained in response thereto outputs the detection result 139 that there is no attack. The training unit 132 may be omitted depending on embodiments, and in this case, the detection unit 134 may obtain the trained learning model 109a from another data processing unit or memory device through the input unit 101.

As described above, because the detection unit 134 performs detection based on the learning model 109a trained in advance, the entire process of detecting the cache side-channel attack may be processed before the cache side-channel attack ends, thereby enabling real-time detection of the cache side-channel attacks.

The above-described apparatus 100 for detecting the cache side-channel attack may be implemented using at least one data processing unit targeted for the cache side-channel attack depending on selection of a designer or user and/or may be implemented using at least one other data processing unit communicatively connected with the processor targeted for the cache side-channel attack. Here, the at least one data processing unit may include, for example, a desktop computer, a laptop computer, a smart phone, a tablet PC, a smart watch, a head mounted display (HMD) device, a navigation device, a portable game machine, a digital television, a set-top box, home appliances (a refrigerator or a robot cleaner, etc.), an artificial intelligence sound reproducing device (an artificial intelligence speaker), a vehicle, a manned or unmanned aerial vehicle, a robot, industrial machinery, or an electronic billboard, but are limited thereto. The above-described method of detecting the cache side-channel attack may be implemented in hardware, or various data processing units in which a program for the above-described method of detecting the cache side-channel attack is installed and embedded may be applied to the above-described apparatus 100 for detecting the cache side-channel attack according to the arbitrary selection of the designer or user.

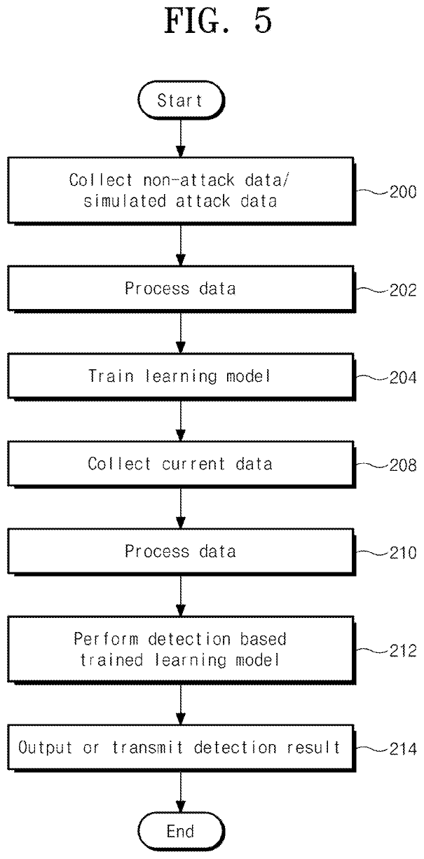

Hereinafter, an embodiment of a method of detecting a cache side-channel attack will be described with reference to FIG. 5.

FIG. 5 is a flowchart illustrating an embodiment of a method of detecting a cache side-channel attack.

Referring to FIG. 5, first, at least one of non-attack data and simulated attack data may be collected and obtained from hardware such as a processor in 200. In this case, the non-attack data and the simulated attack data may be sequentially or alternately collected. Here, the simulated attack for obtaining the simulated attack data may be performed by a designer or a user. The non-attack data or simulated attack data may be obtained from at least one of a core such as a central processing unit, an L1 cache, an L2 cache, and an L3 cache, and when a plurality of cores, a plurality of L1 caches, a plurality of L2 caches, and/or a plurality of L3 caches are provided in the device, and the non-attack data or simulated attack data may be obtained from all cores, all L1 caches, all L2 caches and/or all L3 caches, or may be obtained from some cores, some L1 caches, some L2 cache, and/or some L3 cache. Obtaining the non-attack data and/or simulated attack data may be performed using a hardware performance counter (a group of registers specially designed as an example), and may be additionally performed using a predetermined program such as a performance counter monitoring unit when necessary.

The collected non-attack data and simulated attack data may be further processed as necessary in 202. For example, by analyzing all or some of the collected non-attack data and all or some of the simulated attack data, respectively, data of high need or importance may be selected from all or some of the non-attack data and all or some of the simulated attack data, respectively. Selecting the data may also be performed based on correlation analysis. The data processing process in 202 may be omitted depending on the embodiment.

The collected non-attack data and simulated attack data may be further processed as necessary in 202. For example, by analyzing all or some of the collected non-attack data and all or some of the simulated attack data, respectively, data of high need or importance may be selected from all or some of the non-attack data and all or some of the simulated attack data, respectively. Selecting the data may also be performed based on correlation analysis. The data processing process in 202 may be omitted depending on the embodiment.

The above-described processes from collection of the data to training of the learning model in 200 to 204, depending on situations, conditions or designer's arbitrary choice, may be performed first on the non-attack data and then sequentially on the simulated attack data, may be performed on the simulated attack data first and then sequentially on the non-attack data, may be performed simultaneously on the non-attack data and the simulated attack data, or may be performed arbitrarily regardless of a type of data.

Current data is collected and obtained in 208. Collecting the current data may be performed in the same manner as the collection of the non-attack data or simulated attack data described above, or through some different methods. For example, the current data may be obtained from at least one core, at least one L1 cache, at least one L2 cache, and/or at least one L3 cache using a hardware performance counter or further using a performance counter monitoring unit.

The collected current data may also be processed in 210. When the non-attack data or simulated attack data is processed and then is used for training a learning model, the current data collected in response thereto may also be processed and may be used in the learning model. Processing the current data may include, for example, data selection based on correlation analysis.

Subsequently, the cache side-channel attack is detected using the collected current data or processed current data in 212. Detecting the cache side-channel attack may be performed by applying the collected current data or processed current data to the learning model trained as described above. Accordingly, whether there is the cache side-channel attack corresponding to the current data or processed current data is determined.

A detection result may be visually or audibly output to the outside, or may be transmitted to other external electronic devices or display devices as needed in 214. In addition, the detection result may be temporarily or non-temporarily stored in a storage unit before output or transmission.

The above-described processes from collection of the non-attack data/simulated attack data to training of the learning model in 200 to 204 and the above-described processes from collection of the current data to detection execution in 208 to 212 may be processed by the same data processing unit according to an embodiment, or may be processed by different data processing units. In this case, the different data processing units may be communicatively connected, and one or more data processing units may obtain the trained learning model by performing the processes from collection of the non-attack data/simulated attack data to training of the learning model in 200 to 204 and may transmit the trained learning model to one or more other data processing units, and one or more other data processing units may perform the processes from collection of the above-described current data to detection in 208 to 212 using the trained learning model.

The method of detecting the cache side-channel attack according to the above-described embodiment may be implemented in a form of a program that may be driven by a computer device. Here, the program may include a program command, a data file, a data structure, or the like alone or in combination. The program may be designed and produced using machine code or high-level language code. The program may be specially designed to implement the above-described method, or may be implemented using various functions or definitions that are known and available to those of ordinary skill in a computer software field. In addition, here, the computer device may be implemented including a processor, a memory, and the like that enable function of a program to be realized, and may further include a communication device when necessary.

A program for implementing the above-described method of detecting the cache side-channel attack may be recorded in a computer-readable recording medium. For example, the computer-readable recording medium may include at least one type of physical device capable of storing a specific program executed according to a call such as a computer, such as a semiconductor storage device such as a solid state drive (SSD), ROM, RAM, or flash memory, a magnetic disk storage medium such as a hard disk or a floppy disk, an optical recording medium such as a compact disk or a DVD, a magnetic-optical recording medium such as a floptic disk, and a magnetic tape.

According to the apparatus for detecting the cache side-channel attack and the method of detecting the cache side-channel attack described above, the attack detection on the cache side-channel requiring lots of expertise and the long analysis time may be performed in the short time with the high accuracy.

In addition, it is possible to easily and quickly cope with the attacks of various methods/types/processes, and accordingly, it is possible to appropriately detect and cope with the attacks based on the new method, thereby increasing the flexibility of the attack detection.

In addition, even when the system is not affected or perceived, not only the attack on the cache side-channel may be detected, but also the attack such as acquiring victim data for the short time may be quickly detected and handled.

In addition, the data in the various electronic devices such as the computers or server devices used in the company, government office or internet data center (IDC), the personal communication device, the public computer device, the POS device, the electronic device used in the factory, the vehicle, the manned or unmanned aerial vehicle may be safely and reliably protected.

In addition, it may be applied to various platforms due to high portability.

Although various embodiments of the apparatus for detecting the cache side-channel attack and the method thereof have been described above, the apparatus for detecting the cache side-channel attack and the method thereof are not limited to the above-described embodiments. Various apparatus or methods that are capable of being implemented by modifying and revising based on the above-described embodiment by a person of ordinary skill in the art may also be an example of the above-described apparatus for detecting the cache side-channel attack and the method thereof. For example, although the described techniques are performed in a different order from the described method, and/or components such as systems, structures, devices, and circuits described are combined or associated in a form different from the described method, or other components or an equivalent is replaced or substituted, it may be an embodiment of the above-described apparatus for detecting the cache side-channel attack and method thereof.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. An apparatus for detecting a cache side-channel attack, the apparatus comprising:
a data collection unit configured to collect data from at least one of a core, an L1 cache, an L2 cache, and an L3 cache, respectively; and
a detector configured to obtain a detection result corresponding to the data using at least one trained learning model.

2. The apparatus of claim 1, wherein The data collection unit includes: a hardware performance counter that obtains and records data on hardware activity from at least one of a core, an L1 cache, an L2 cache, and an L3 cache.

3. The apparatus of claim 1, further comprising a data processing unit configured to process the data by performing a correlation analysis on the data.

4. The apparatus of claim 1, further comprising a training unit configured to obtain the at least one trained learning model by training at least one learning model using the data.

5. The apparatus of claim 4, wherein the data includes
non-attack data obtained from at least one of the core, the L1 cache, the L2 cache, and the L3 cache in absence of the cache side-channel attack; and
simulated attack data obtained from at least one of the core, the L1 cache, the L2 cache, and the L3 cache in presence of a simulated attack.

6. The apparatus of claim 4, wherein the at least one learning model includes at least one machine learning model of a multi-layer perceptron, a support vector machine (SVM), a deep neural network (DNN), a convolutional neural network (CNN), and a recurrent neural network (RNN), a deep belief network (DBN), a deep Q-network, a long short term memory (LSTM), a generative adversary neural network (GAN) and a conditional generative adversarial neural network (c GAN).

7. A method of detecting a cache side-channel attack, the method comprising:
collecting data from at least one of a core, an L1 cache, an L2 cache, and an L3 cache, respectively; and
obtaining a detection result corresponding to the data using at least one trained learning model.

8. The method of claim 7, wherein the collecting of the data from the at least one of the core, the L1 cache, the L2 cache, and the L3 cache, respectively, includes obtaining and recording data on hardware activity from the at least one of the core, the L1 cache, the L2 cache, and the L3 cache.

9. The method of claim 7, further comprising processing the data by performing a correlation analysis on the data.

10. The method of claim 7, further comprising training at least one learning model using the data to obtain the at least one trained learning model.

11. The method of claim 11, wherein the data includes non-attack data obtained from at least one of the core, the L1 cache, the L2 cache, and the L3 cache in absence of the cache side-channel attack; and
simulated attack data obtained from at least one of the core, the L1 cache, the L2 cache, and the L3 cache in presence of a simulated attack.

12. The method of claim 11, wherein the at least one learning model includes at least one machine learning model of a multi-layer perceptron, a support vector machine, a deep neural network, a convolutional neural network, and a recurrent neural network, a deep belief network, a deep Q-network, a long short term memory, a generative adversary neural network and a conditional generative adversarial neural network.
